(19) United States
(12) Patent Application Publication
(10) Pub. No.: US 2026/0279972 A1
(43) Pub. Date: Sep. 17, 2026

(54) METHOD FOR HEATING AN HV BATTERY

(71) Applicant: Dr. Ing. h.c. F. Porsche Aktiengesellschaft, Stuttgart (DE)

(72) Inventors: Marcus GSELL, Leonberg (DE); Tim PAWLAK, Nürtingen (DE); Adrian UMERLE, Stuttgart (DE)

(21) Appl. No.: 19/562,864

(22) Filed: Mar. 11, 2026

(30) Foreign Application Priority Data
Mar. 14, 2025 (DE) 10 2025 109 774.7

(51) Int. Cl. H01M 10/663; B60L 58/27; H01M 10/615; H01M 10/625

(52) U.S. Cl. CPC H01M 10/663; B60L 58/27; H01M 10/615; H01M 10/625; B60L 2240/545; H01M 2220/20

(57) ABSTRACT

A method heats an HV battery of a motor vehicle. The method includes the steps of heating the HV battery to a predefined temperature point that is below a target temperature; and heating via residual heat from a thermal capacity of a drive of the motor vehicle to the target temperature of the HV battery.

### CROSS REFERENCE TO RELATED APPLICATIONS

This application claims benefit to German Patent Application No. DE 10 2025 109 774.7, filed on March 14, 2025, which is hereby incorporated by reference herein.

### FIELD

The invention relates to a method for heating a high-volt (HV) battery. The invention also relates to a motor vehicle.

### BACKGROUND

Heating of HV batteries is known in the art.

DE 10 2023 135 044 A1 describes a vehicle that includes an electric machine that includes a rotor. The vehicle further includes a traction battery configured to provide electrical power to the electric machine. The vehicle further includes a wheel mechanically coupled to the electric machine. The vehicle further includes one or more controls programmed to rotate the rotor to a preset position such that the wheel rotates in response to detecting that a battery temperature is below a threshold value and that the vehicle is parked.

EP 4 033 587 B1 describes that when a vehicle is in a parked state and the battery is to be heated, a switch-on valve is switched on, switch-on valves are switched off, a first pump is started, a second pump is stopped, and a cooler is stopped. In that case, the heat received by the cooling liquid is used to heat the battery, wherein a bus bar current is very low, and wherein the heat of the cooling liquid is from the heat generated by the motor windings.

EP 2 540 552 B1 describes a device in an electric vehicle, including an electric motor with a drive, operated with energy from an energy storage system, including a field-oriented motor controller generating the motor control signals for the electric motor, wherein the motor control signals are responsive to a flux command signal and a torque command signal; a torque command computer, coupled to the motor controller and generating the torque command signal to command a desired torque; an optimal efficiency controller coupled to the torque command computer, generating an operating efficiency flow to operate the electric motor at a first determinable efficiency using a first power from the energy storage system while providing the desired torque; an excess loss controller generating an inefficient flow to operate the electric motor at a second determinable efficiency using a second power from the energy storage system independent of the desired torque, wherein the second power is greater than the first power; and a mode controller adjusting the flux command signal using one of the optimal efficiency flows and the inefficient flow.

The described heating methods and devices are perceived as being worthy of improvement.

### SUMMARY

In an embodiment, the present disclosure provides a method for heating an HV battery of a motor vehicle. The method includes the steps of heating the HV battery to a predefined temperature point that is below a target temperature; and heating via residual heat from a thermal capacity of a drive of the motor vehicle to the target temperature of the HV battery.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of an exemplary embodiment of a method for heating an HV battery according to the present disclosure.

### DETAILED DESCRIPTION

Embodiments of the present disclosure improve a heater of an HV battery.

Features and details described in connection with the method according to embodiments of the present disclosure for heating an HV battery also apply in connection with the motor vehicle according to embodiments of the present disclosure. This also applies inversely in each case, so that reference to the individual aspects of the embodiments is or can always be made to one another in relation to the disclosure.

A method for heating an HV battery of a motor vehicle can be configured. The method according to an embodiment of the present disclosure may comprise the step of heating an HV battery to a predefined temperature point that is below a target temperature. The method may comprise the step of heating via residual heat from the thermal capacity of a drive of the motor vehicle up to the target temperature of the HV battery. When the battery is cold, only small currents may be received and discharged. Heating the battery can improve performance to a certain extent.

Drives may have a thermal mass. That is to say, once heated, they still have to deliver thermal energy. This thermal energy may be used to heat up the HV battery.

HV battery refers to a high-voltage battery used in electric vehicles. These batteries have a higher voltage than conventional car batteries and have been specifically designed for use in electric vehicles.

According to an embodiment of the present disclosure, the step of heating an HV battery to a predefined temperature point means that the battery is heated until it has reached a certain predefined temperature, but is below the target temperature. The target temperature is the desired maximum temperature of the battery.

According to an embodiment of the present disclosure, the step of heating via residual heat from the thermal capacity of the propulsion of the motor vehicle up to the target temperature of the HV battery means that the battery is heated by heating with the residual heat of the propulsion of the vehicle. The thermal energy that is in the motors and other components of the drive is used to heat the battery.

When the battery is cold, only small currents may be received and discharged. Heating the battery may represent some performance as it helps the battery operate more efficiently and last longer.

In one aspect, heating of the HV battery to the predefined temperature point may occur via a heater.

A heater is, in particular embodiments, a device that can be used to heat a fluid, such as a liquid or a gas. In that case, the heater may be used to heat the HV battery of a motor vehicle to the predefined temperature point.

A heater may conduct a high amount of energy into the battery in a short time to heat it. The heater gives the ability to accurately control and regulate the temperature of the battery to ensure it is not overheated. A heater may help to quickly bring the battery to a safe temperature to prolong the life of the battery and minimize the risk of accidents or damage. A heater may help to quickly bring the battery to a desired temperature to accelerate the vehicle start and reduce the total time of the start operation.

In one aspect, heating of the HV battery to the predefined temperature point via an active heater by the drive may occur. A drive may also be operated at operating points where a drive torque is not provided but losses are generated. Thus, a separate heater may be omitted, which may conserve resources in both manufacturing and operation.

The aspect describes a method of heating HV batteries by active heater by the drive. This method does not require separate heating devices, as the vehicle's own drive system is used to heat the battery.

By using its own drive, a separate heater may be omitted, which may lead to savings in resources during manufacture and operation.

An advantage of methods according to embodiments of the present disclosure is also that it is possible to actively heat the battery during operation without this affecting the performance of the engine. This may help to bring the battery to a desired temperature more quickly and thus improve the startup behavior.

Another advantage is that by using the drive as a heater, it is also possible at operating points in which no drive torque is provided but losses are generated. These losses can be harnessed to heat the battery and thus achieve higher efficiency.

If a heater is not used, this may also cause the weight of the vehicle to be reduced as there is no need for separate heaters. Again, this may have a positive effect on the performance and consumption of the vehicle.

In one aspect, the method according to embodiments of the present disclosure may comprise the step of using the drive during a charging process to heat the HV battery. When the battery is cold, only small currents may be received and discharged. Heating the battery may shorten the charging time to represent some performance.

The aspect describes a method for heating the high-voltage battery (HV battery) of a motor vehicle in which, during the charging process, the propulsion of the vehicle is used to heat the battery. This step may help to heat the battery faster and thus reduce the charging time.

The step of using the drive during the charging process to heat the HV battery is, in particular embodiments, to actively operate the drive during the charging process in order to contribute some amount of thermal energy to the heating of the battery. In this process, the residual heat of the drive may also be used to heat the HV battery. This may help the battery to heat up faster and thus achieve higher power (performance) when starting the vehicle.

In one aspect, the HV battery may be heated to maximum heating power of the engine. This allows for efficient use of energy and reduces time for heating the battery. In particular embodiments, the power of the drive is used to transfer heat energy to the HV battery and to bring it to the desired temperature more quickly.

An advantage of this approach is that it allows for faster heating of the battery and thus reduces the energy consumption of the vehicle at low temperatures. In addition, this may also help to ensure that the battery is heated more uniformly and thus its service life is increased.

According to one aspect, after the charging process, in particular embodiments during the driving off, a cooling circuit of the motor vehicle can be connected so that the residual heat of the drive is directed from the charging process into the internal space, so as to heat the internal space. The drive cooling circuit may be coupled to the internal cooling circuit.

The cooling circuit of a motor vehicle is, in particular embodiments, a system used to remove heat that may be generated by the operation of the drive. In particular, it comprises various components such as a cooler, water cooling and thermostat.

The cooler is, in particular embodiments, a device that can be used to remove the heat from components of the drive. In particular, it comprises a cooler vessel and a number of heat sinks filled with liquid. The fluid, in particular the liquid or the gas, is in particular pumped through the cooler and receives heat on the inside of the heat sinks, where it receives heat from the drive in order to release it elsewhere via heat sinks.

Water cooling is another component of the cooling circuit used to regulate the temperature of the cooling system. It consists of a cooler and a thermostat. The cooler is a device that removes the heat from the liquid and releases it to the environment. In particular embodiments, the thermostat is a safety device that can ensure that the liquid in the cooling system is moved over precisely defined temperature limits.

The drive cooling circuit may be coupled to the internal cooling circuit to direct the residual heat of the drive from the charging process into the internal space to thus heat the internal space. To this end, a control device may read machine-readable instructions of a computer program product from a memory device to enable valves and/or pumps to be controlled to switch the cooling circuit of the motor vehicle, in particular embodiments an electric machine of the motor vehicle, to connect an interior cooling circuit to the same to facilitate heat transport into the interior space.

The advantages of the method according to embodiments of the present disclosure are, among other things, increasing energy efficiency by utilizing the residual heat of the drive and thus decreasing energy consumption and, if necessary CO2 emissions, as well as improving the comfort factors for the passengers.

According to one independent aspect, a motor vehicle may be configured and adapted to perform any of the methods of the embodiments of the present disclosure as described elsewhere herein.

The motor vehicle can be described by the features, features and advantages of methods of embodiments of the present disclosure, or both. This also applies across the category limits of methods, apparatus and system. Thus, methods can also be described by the features, properties and advantages of the electronic signal. A repeat of all these features, properties and advantages is omitted for the sake of readability and compactness.

Further advantages, features, and details of the embodiments of the present disclosure arise from the following description, in which example embodiments of the invention are described in detail with reference to the drawings. The features mentioned in the claims and in the description can be included in embodiments of the present disclosure individually or in any combination.

By way of example, an HV battery may have a temperature of -10°C and may be heated to 10°C for a certain battery performance x. That is to say, the battery would be heated by 20K. An operational strategy may be to allow the drive to heat until the target temperature is reached. The method described herein now allows only up to, for example 5°C battery temperature, wherein the remaining 5°C can no longer be actively heated, but the residual heat can be drawn from the thermal capacity of the drive. This allows electrical energy and thus the range to be saved.

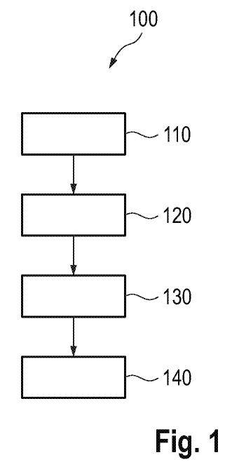

In particular, the method 100 shown in FIG. 1 can be the step 110 of heating an HV battery to a predefined temperature point that is below a target temperature; and heating 120 via residual heat from the thermal capacity of the drive up to the target temperature of the HV battery.

Here, heating 110 of the HV battery to the predefined temperature point may occur via a heater.

Heating 110 of the HV battery to the predefined temperature point occurs, in particular, via an active heater by the drive.

Method 100 may comprise step 130 of using the drive during a charging process 135 to heat the HV battery. In so doing, the HV battery may be heated with maximum heating power of the drive.

According to one aspect, after the charging process 135, in particular during driving off 140, a cooling circuit of the motor vehicle can be connected so that the residual heat of the drive is directed from the charging process into the internal space, so as to heat the internal space. To this end, a control device may read machine-readable instructions of a computer program product from a memory device to enable valves and/or pumps to be controlled to switch the cooling circuit of the motor vehicle, in particular an electric machine of the motor vehicle, to connect an interior cooling circuit to the same to facilitate heat transport into the interior space.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for heating an HV battery of a motor vehicle, comprising:
heating the HV battery to a predefined temperature point that is below a target temperature; and
heating, via residual heat from a thermal capacity of a drive of the motor vehicle, the HV battery to the target temperature.

2. The method according to claim 1, wherein the heating of the HV battery the predefined temperature point uses a heater.

3. The method according to claim 1, wherein the heating of the HV battery to the predefined temperature point occurs via an active heater through an engine.

4. The method according to claim 1, further comprising a using the drive during a charging operation to heat the HV battery.

5. The method according to claim 4, wherein the HV battery is heated with a maximum heating power of the drive.

6. The method according to claim 1, wherein after a charging process, a cooling circuit of the motor vehicle is connected so that the residual heat of the drive is directed from the charging process into an internal space, so as to heat the internal space.

7. The method according to claim 6, wherein the cooling circuit of the motor vehicle is connected during driving off.

8. The motor vehicle configured and adapted to perform the method according to claim 1.
